(19) United States
(12) Patent Application Publication
(10) Pub. No.: US 2002/0131070 A1
(43) Pub. Date: Sep. 19, 2002

(54) Using e-mail to facilitate soft proofing and for print job status

(76) Inventors: Edward M. Housel, Rochester, NY (US); Mark Reeder, Rochester, NY (US)

Correspondence Address: MCDONNELL BOEHNEN HULBERT & BERGHOFF, 300 SOUTH WACKER DRIVE, SUITE 3200, CHICAGO, IL, 60606, US

(21) Appl. No.: 09/809,962

(22) Filed: Mar. 16, 2001

(51) Int. Cl. G06F 15/00; B41J 1/00

(52) U.S. Cl. 358/1.15; 358/402

(57) ABSTRACT

Methods and systems for generating an electronic proof set of a digital print job and delaying the completion of the print job until the proof set is approved are presented. The invention further includes generation of an electronic proof set that is transmitted for approval via email.

### FIELD OF INVENTION

The present invention relates generally to the field of digital imaging. More particularly, it relates digital imaging for the purpose of printing documents and images and methods for improving the efficiency of such printing.

### BACKGROUND OF THE INVENTION

High speed digital printers are in common use today for many production processes ranging from printing of a single document to large scale production of multiple copies of documents. In a typical system, the document or image to be printed is as represented by digital data. This data can be created either through scanning or digital generation of the document or the image via a computer. This data is typically supplied to a printer over a network connection. The data is then processed by a raster imaging processor (RIP) associated with the printer and converted to a format usable by the printer to recreate the image.

Historically, once a print job was sent to a printer, it had to run its course, resulting in the job going to completion even if errors were detected before the print was complete. Prior art printers included mechanisms by which an operator could cancel a print job, but typically these mechanisms require an unusually high degree of operator involvement in the print job. Thus, often print jobs had to be printed multiple times because of problems later found in the print job. This is especially troublesome in large print jobs with multiple copies of a document being printed, as the need to rerun the print job was expensive and wasteful.

Some of the newer printers allow for the generation of a proof set to allow the operator to check the print job before multiple copies are run. The printer receives a print job from the RIP and prints a proof set. The print job is then put into a hold queue while an operator reviews the proof set for accuracy before running the entire production run. Such proofing is an effective method for conserving resources and decreasing costs by avoiding the generation of multiple copies of a job with errors. If the operator uncovers errors in the proof set, then steps are taken to correct the errors before further expense or waste is incurred.

While the ability to generate a proof set is helpful, the current method of printing a proof set, hand delivering the proof set to the customer, and waiting for the customer to review the print job before canceling or printing the print job is expensive, slow, and generally inefficient. Large or complex print jobs in particular increase the time and expense of the current method. Accordingly, there is an increased demand by customers to be able to check that a print job will print as desired even before generating a proof set. Thus, there remains a need for a method that eases the review of proof sets of print jobs.

In addition to the above, there is also a demand to increase the speed and efficiency of collecting billing and accounting information from individual printers. Currently, billing and accounting information can only be obtained by manually accessing each individual machine. This method is time consuming, slow, and inconvenient.

### SUMMARY OF THE INVENTION

In the present invention methods are provided to enhance the ability and the efficiency of making corrections to a proof set. At the time a digital representation of a document or image is processed by the RIP, information that can assist in the processing of proof sets can be or is available. Such information includes input page number, output page number, special commands and the like. In the present invention, such information further includes an electronic generation of a proof set. The present invention then makes the information from the RIP available to the operator or customer electronically, such as on an HTML page or contained in or attached to an e-mail. The information could then be used to help in the proofing process. Once the job has cleared the proofing process, the print job can either be cancelled or the operator can be instructed to print the job.

One aspect of the present invention is directed to a method of printing a proof set of a document. In the method, a print job is analyzed to determine whether a proof set should be printed on an HTML page or sent to the customer via email. After making that determination, the pages of the print job are rasterized and stored in a raster memory file. This raster memory file includes not only the rasterized page but also rasterized information relating to the features. The electronic proof set is then created and an email is sent to the customer. The print job is placed in a hold queue while the proof set can be reviewed. The print job is released from the hold queue upon receipt of operator instructions indicating approval of the proof set. The print job is then printed in final form, suppressing any feature information that was printed on the pages of the proof set.

Another aspect of the invention allows the printer to send emails regarding the status of a print job. The emails regarding status can include both print status messages (the job is spooling) and accounting information (billing meter values).

These and other aspects of the invention will become more evident in the detail description of the invention below.

### BRIEF DESCRIPTION OF THE DRAWINGS

FIG. 1 depicts a typical layout of a digital printing system

FIG. 2 is a detailed layout of the digital printer utilized by the claimed methods.

FIG. 3 is a flow chart illustrating aspects of the process of the present invention.

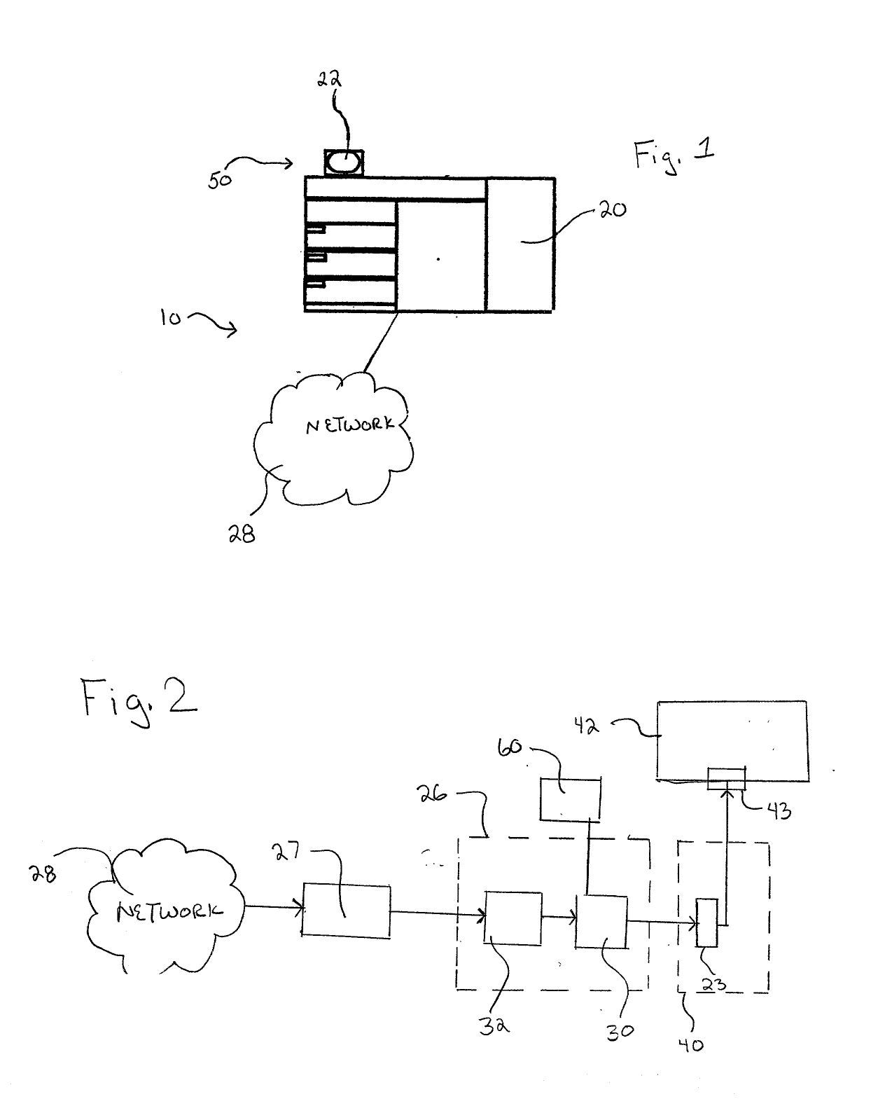

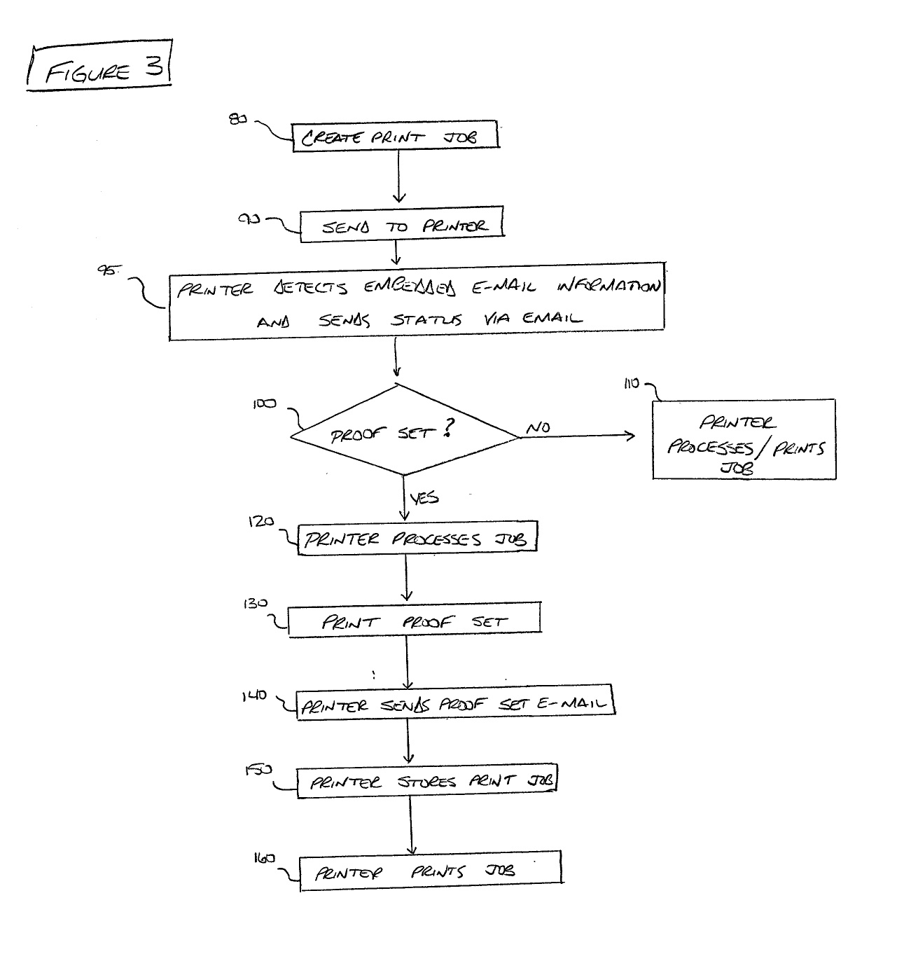

### DETAILED DESCRIPTION OF PREFERRED EMBODIMENTS

Referring to FIGS. 1 & 2, a typical print system of the type employing the present invention includes a digital printer 20, preferably a high speed digital printer, having a printer user interface 22. While the exemplary print system 10 shown is a network printing system configured to receive remote input through a network connection, other configurations are contemplated and possible within the scope of the present invention. For example, a system where input is local and/or where multiple printers are connected to the same network would be within the scope of the present invention. While a particular printer configuration is discussed herein, it is to be understood that the present invention may be incorporated in other printing system configurations.

The printer 20 includes a raster image processor (RIP) 26 that receives incoming data from a network 28 to which the printer 20 is connected. Prior to being transferred to the raster image processor 26, the print job may be held in a print server queue 27 on the network 28. The raster image processor 26 includes processing unit 30, that receives control commands and data from the network 28. Control commands are translated into machine control language by the processing unit 30, while incoming print jobs and program codes are stored in a print job buffer 32, also referred to as the RIP queue.

The printer 20 also includes a marking engine 40, that incorporates standard paper handling and processing equipment necessary, for example, for producing images on output paper. The marking engine 40 receives and stores in a multiple page image buffer 23, a data stream, including image data and control data generated by the processing unit 30. The image data is processed and transmitted to a write head (not shown) for transfer to the output pages.

The marking engine 40 also includes output devices that transfer the printed output pages to one or more finishing devices 42 connected to the printer 20 by a simple electrical connection 12. The finishing device 42 includes a finishing device user interface 43. The finishing device 42 may be any commonly used finishing device, such as a hole punch or binder.

The printer 20 includes a logic control center 50, including a printer user interface 22, through which the operator inputs functions and receives messages from the printer 20. The printer 20 also includes a database 60 of shared instructions, stored on a local disk, accessed by the RIP 26. The instructions stored in the database 60 include, for example, setup instructions for a particular finishing device that are to be followed by the operator in all cases, regardless of the particular configuration chosen. Generally, these instructions will include directions as to how to physically set up a given finishing device. For example, a hole punch may have detents that must be physically moved to a desired position, but are secured by spring-loaded pins that must be removed prior to moving the detents.

At the highest level, the print job must come to the RIP 26 with some important job request information. This information is generally referred to as features of the print job. One such feature is a request for a proof set. The present invention relates to print jobs including such a feature.

Digital printing requires that an electronic version of the document to be printed (the print job or the input job) be prepared. Typically, the electronic version of the document is a computer readable file written in a Page Description Language (“PDL”), of course other formats would work, as well. PDL files contain commands in American Standard Code for Information Interchange (“ASCII”) format. An advantage of storing a document as a PDL file is that the PDL file is typically much smaller than if the document were stored as a bitmapped image file. The printing device reads the PDL file and performs printing functions according to the instructions in the PDL file. Sending instructions to the printing device in ASCII code is more efficient than creating a bitmapped image of the document and then sending the bitmapped image to the printing device. For example, it is much more efficient to send a few ASCII characters to the printing device that instruct the printing device to print the string “PDF” in 24 point Times New Roman font than it is to create a bitmapped image of the string at 600 dots per inch resolution and then send the whole bitmapped image to the printing device. Examples of PDL file formats are the Portable Document Format (“PDF”) format and the PostScript format, both by Adobe Systems Inc. of Palo Alto, Calif.

PDL files are typically stored on a computer readable medium and are accessible by a computer running a Print Document Management System program. When ready for printing, the printer operator sends some or all of the PDL file to a raster imaging processor (RIP). The RIP processes the PDL instructions that it receives and instruct associated printers to print one or more pages of the document. It is to be understood, however, that the present invention is not limited to the devices or configuration that use a PDL format. Many other formats for storing the document in electronic form are possible, such as in graphical format, and on other storage media, and the present invention is not restricted to the formats and media described herein.

Raster imaging processors are widely used in the art. The principal function of the RIP is to process the input job into rasters or a stream of bits representing either black or white, or one of sixteen levels of gray for each element of the image. In doing this processing the RIP has a great deal of information about the input job that can help manage the printing of the job.

FIG. 3 is a flow chart illustrating the operation of the present invention. In the method of the present invention, the printer 10 through its associated RIP 26 analyzes the print job to determine the proper handling of the job. As shown in FIG. 3, a print job is initially created 80 and sent to the printer 90. Preferably, the print job will be created as a PDL file, as described above, and will contain embedded email information such as the email address of the person responsible for proofing the print job and any request to review an electronic proof set. Once the print job is sent to the printer 90, it is received by the RIP 26, and the embedded email information is detected. 95 In the preferred embodiment of the claimed inventions, the RIP 26 immediately sends an email regarding the status of the submitted print job to the detected address, and continues to send such status emails throughout the printing process. Such email status messages will include messages such as “Job has spooled,” and “Job is interpreting.”

In its detection of the embedded email information, the RIP 26 in the printer must also determine whether the print job requests a proof set. 100 If there is no request for a proof set, the print job is sent for printing as normal 110. If there is a request for a proof set, then the print job is processed by the data processor 120 in the printer. In the preferred embodiment of the claimed invention, the processing step is completed by the RIP 26. The RIP 26 preferably rasterizes the pages of the print job in step 120. For example, if there is a request to print feature information on the page of the proof, then the RIP 26 creates a raster memory for the proof page using the features in the print job and the RIP 26 further rasterizes feature information and stores it in the same raster memory.

Following the rasterization of the print job in the preferred embodiment, in step 130, the raster memory is used to create a proof set of the print job in an electronic media. In one embodiment of the invention, the proof set could be prepared as an email message describing in detail how the job would print, including feature information such as the number of pages, the type of media chosen for each page, and the finishing options chosen, as well as the text that occurs on each page. In another embodiment of the invention, the proof set could be prepared as a separate file, such as a PDF file, including the raster image of each page side of the print job and the feature information described above. In the preferred embodiment of the present invention, the proof set is prepared on an html page containing a raster image of each page side of the print job. As part of the proof set creation in step 130, the RIP 26 confirms that all the pages of the print job have been prepared.

Once all of the pages in the proof set are created in a selected electronic file, the printer sends an email to the detected address with the complete electronic proof set. 140 The email either contains the electronic proof set as the text of the email, attaches the electronic proof set as an attached file, or contains a link to the html page for the electronic proof set. In order to avoid long emails and emails with large attachments which tend to create network problems, an html page is preferred in this invention. The emails may also contain special job codes or provisions for electronic signature.

Once all the pages in the proof set are created, step 150 puts the print job in a hold queue. The job remains in the hold queue until the person responsible for proofing the print job approves the job. In order to approve of or cancel a print job, the proof set reviewer may respond to the email using a specially designated job approval code or a digital signature. In the preferred embodiment, the job approval codes will be different depending on whether the print job is being accepted, cancelled, or being given special instructions. In the alternative, the job could be approved by simply making a telephone call to the printer operator. If the job is approved, in step 160 the print job is released from the hold queue and the final job is printed. If the print job is rejected, the job is canceled and erased from the hold queue without being printed.

It will be appreciated that scope and nature of the feature information printed on the pages of the proof set can be varied. It can include, job level and/or page level features. It is also not necessary the feature information be printed on every page of the proof set. For example, job level feature may only be printed on the first page of the job and not page level features be printed at all. As another example, it may be desired that only selected features be printed and that feature may only apply to certain pages. For example, one common feature of print jobs is plex. Plex refers to whether the printing is to single sided (simplex) or two sided (duplex). It may be desirable to have the information as to the plex feature printed on the proof pages to confirm where within the document the feature is changed. Thus through the present invention the information is printed on the pages of the proof set and the operator can confirm the feature with the print results. Moreover, if necessary the operator can determine where the feature changes in order to make appropriate changes to the feature settings.

Thus, with the present invention the operator, or any person who views the page of the proof set, can see the feature information associated with the page that resulted in the proof page being printed in the manner in which it was printed. Having this information makes it easier to adjust the features should the proof page not be printed in the manner desired.

For keeping track of multiple jobs, the system can be configured to send accounting files via email to pre-configured email addresses. Using this mechanism, the customer can view the outcome of several jobs at their local computer. This same email could be used to create customer billing information without having to walk back to the printer and request accounting information on the printer's user interface. In the preferred embodiment of the current invention, the printer sends an email notification to the pre-configured email addresses that a new accounting log has been saved on the system. The accounting log file is preferably attached to the notification email, thus eliminating the need to retrieve the log file from the printer. Those skilled in the art will further recognize that this email function, with or without the data attachment, can be set to run automatically allowing the delivery of accounting information on a time schedule established by a printer administrator.

It should be understood that the illustrated embodiments are exemplary only and should not be taken as limiting the scope of the present invention. For example, the invention can be used with various protocols and is not limited to the protocols detailed herein. The claims should not be read as limited to the order or elements unless stated to that effect. Therefore, all embodiments that come within the scope and spirit of the following claims and equivalents thereto are claimed as the invention.

I claim:

1. A method of monitoring the status and assuring the accurate completion of a print job comprising the steps of:
Entering a print job in machine readable form;
Embedding email information in the print job;
Sending the print job to a printer;
Analyzing a print job to detect email information;
Sending email messages from the printer regarding the status of the print job;
Processing the pages of the print job and storing the processed pages in a memory file;
Sending an email message from the printer regarding how the print job will print.

2. The method of claim 1 wherein the email information embedded in the print job further comprises a request for an electronic proof set and for email transmission of the electronic proof set.

3. The method of claim 2 wherein the email information embedded in the print job further comprises email address information for a person or persons to receive email notification of status information or email transmission of an electronic proof set.

4. The method of claim 1 wherein the step of analyzing a print job to detect email information further comprises the detection of email address information and requests for email proof sets.

5. The method of claim 1 wherein the step of processing the pages of the print job and storing the processed pages in a memory file is completed by rasterizing the pages of the print job and storing the rasterized pages in a raster memory.

6. The method of claim 1 wherein the information regarding how the print job will print is sent in the text of an email message.

7. The method of claim 1 wherein the information regarding how the print job will print is sent in a file attachment to an email message.

8. The method of claim 1 wherein the information regarding how the print job will print is recorded on an html page that is supplied in an email message.

9. The method of claim 1 further comprising the steps of:
storing the print job in a hold queue while awaiting a response to the email message regarding how the job will print; and
releasing the print job from the hold queue.

10. The method of claim 1 wherein the memory file further comprises a job information log that can be supplied in the email messages from the printer regarding the status of the print job.

11. The method of claim 10 further comprising the step of converting the job information log to a human readable form.

12. The method of claim 10 wherein the job information log further comprises an accounting log.

13. The method of claim 1 further comprising the step of creating an electronic proof set.

14. The method of claim 13 wherein the step of creating an electronic proof set is completed by accessing the raster memory and creating files of raster data in an electronic medium.

15. The method of claim 13 wherein the step of sending an email message from the printer regarding how the print job will print is completed by sending the pages of the electronic proof set in a file attachment to an email message.

16. The method of claim 15 wherein the file attachment is a PDF file.

17. The method of claim 15 further comprising the steps of:
storing the print job in a hold queue while awaiting a response to the email message regarding how the job will print; and
releasing the print job from the hold queue.

18. The method of claim 17 wherein the step of releasing the print job from the hold queue occurs following the receipt of a print job approval communication.

19. The method of claim 18 wherein the print job approval communication comprises an email having an approval code for the print job.

20. The method of claim 18 wherein the print job approval communication is received by a printer operator.

21. The method of claim 14 wherein the electronic medium is an html page and the step of sending an email message from the printer regarding how the print job will print is completed by supplying the html address or page in an email message.

22. The method of claim 21 further comprising the steps of:
storing the print job in a hold queue while awaiting a response to the email message regarding how the job will print; and
releasing the print job from the hold queue.

23. The method of claim 22 wherein the step of releasing the print job from the hold queue occurs following the receipt of a print job approval communication.

24. The method of claim 23 wherein the print job approval communication comprises an email having an approval code for the print job.

25. The method of claim 23 wherein the print job approval communication is received by a printer operator.

26. A method of monitoring the status and assuring the accurate completion of a print job comprising the steps of:
Entering a print job in machine readable form;
Embedding email information in the print job;
Sending the print job to a printer;
Analyzing a print job to detect email information and determine whether an electronic proof set should be printed;
Sending email messages from the printer regarding the status of the print job;
Rasterizing the pages of the print job and storing the rasterized pages in a raster memory;
Creating an electronic proof set;
Sending the electronic proof set in an email message from the printer;
storing the print job in a hold queue;
releasing the print job from the hold queue.

27. The method of claim 26 wherein the email information embedded in the print job further comprise a request for an electronic proof set and for email transmission of the electronic proof set.

28. The method of claim 27 wherein the email information embedded in the print job further comprises email address information for a person or persons to receive email notification of status information or email transmission of an electronic proof set.

29. The method of claim 26 wherein the electronic proof set is sent in the text of an email message.

30. The method of claim 26 wherein the electronic proof set is sent in a file attachment to an email message.

31. The method of claim 30 wherein the file attachment is a PDF file.

32. The method of claim 26 wherein the electronic proof set is an html page that is supplied in an email message.

33. The method of claim 26 wherein the step of releasing the print job from the hold queue occurs following the receipt of a print job approval communication.

34. The method of claim 33 wherein the print job approval communication comprises an email having an approval code for the print job.

35. The method of claim 33 wherein the print job approval communication is received by a printer operator.

36. The method of claim 26 wherein the memory file further comprises a job information log that can be supplied in the email messages from the printer regarding the status of the print job.

37. The method of claim 36 further comprising the step of converting the job information log to a human readable form.

38. The method of claim 36 wherein the job information log further comprises an accounting log.

39. The method of claim 26 wherein the step of creating an electronic proof set is completed by accessing the raster memory and creating files of raster data in an electronic medium.
